(19) United States
(12) Patent Application Publication
(10) Pub. No.: US 2001/0017122 A1
(43) Pub. Date: Aug. 30, 2001

(54) Internal-combustion engine with improved reciprocating action

(76) Inventor: Luciano Fantuzzi, Brescello (IT)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/794,109

(22) Filed: Feb. 27, 2001

(30) Foreign Application Priority Data
Feb. 29, 2000 (IT) M02000A000031

(51) Int. Cl. F02B 75/32

(52) U.S. Cl. 123/197.4

(57) ABSTRACT

An internal-combustion engine with improved reciprocating action comprises at least one hollow cylinder inside which there is provided a chamber for the activity of a working fluid, the cylinder having an end which is closed by a head provided with intake and exhaust valves for the fluid and an opposite end which is closed by a piston which can slide with a reciprocating rectilinear motion in the chamber, and a device for converting the reciprocating rectilinear motion of the piston into a rotary motion of an engine shaft which is constituted by at least one pusher rod which is substantially perpendicular to the longitudinal axis of the engine shaft and has a first end which is associated with the piston and a second end which is provided with pusher elements, and by at least one shaped eccentric element which is keyed on the shaft and on which there is provided a circuit element whose path can be traced by the pusher elements which are mechanically coupled thereto, the activity of the fluid in the chamber being adapted to impart to the piston a thrust for actuating the rod with a reciprocating rectilinear motion parallel to itself, with the sliding of the pusher elements in the circuit element in order to transfer the thrust to the eccentric element for the rotary actuation of the engine shaft.

### BACKGROUND OF THE INVENTION

The present invention relates to an internal-combustion engine with improved reciprocating action for mobile and fixed or stationary applications, such as engine vehicles, watercraft, aircraft, compressors, pumps, or other machine tools or manufacturing machines.

Internal-combustion engines with four-stroke reciprocating action are known in which the conversion of the working fluid into energy occurs according to known cycles, i.e. the Otto cycle in spark-ignition engines and the Diesel cycle in compression-ignition engines; each cycle comprises intake, compression, power and exhaust steps.

In conventional four-stroke engines, a complete cycle is performed in four successive strokes of a piston, being produced every two revolutions of the engine.

Considering schematically the operation of a conventional four-stroke engine, the first 180° of the rotation of the engine shaft (first stroke of the piston) correspond to the intake step, in which the working fluid is introduced in the cycle; the second 180° (second stroke of the piston), which complete the first revolution, correspond to the step for compression of the fluid while the intake and exhaust valves are closed; the next 180° (third stroke of the piston) correspond to the useful combustion and expansion step, which occurs while the valves are closed; finally, the last 180° (fourth stroke of the piston), which complete the second revolution of the engine shaft, correspond to the exhaust step, in which the exhaust valve is open and the combustion products are discharged externally.

The thermodynamic cycle of a conventional four-stroke engine is performed every two revolutions of the engine shaft, i.e. a useful step (power step) occurs every 720° of rotation.

Two-stroke reciprocating internal-combustion engines are also known in which the conversion of the working fluid into energy occurs according to thermodynamic cycles which occur at each revolution of the engine shaft, so that there is a useful stroke every 360° of rotation.

Therefore, a two-stroke engine, cylinder capacity and rpm rate being equal, should in theory deliver twice the power of an equivalent four-stroke engine.

However, in the two-stroke engine this result cannot be achieved owing to two phenomena linked to its operation: the loss of a significant fraction of the charge of working fluid during the scavenging step and the reduction of the geometric cylinder capacity owing to the exhaust and scavenging ports.

Conventional types of engine have an ordinary crank mechanism (connecting rod-and-crank system) which allows to convert the motion from rectilinear and reciprocating to rotary.

In this case, the piston is connected to the engine shaft by means of a connecting rod, in which the small end is pivoted to the piston pin and the big end is coupled to the crank pin of the engine shaft, known as crankshaft; the small end moves with a reciprocating rectilinear motion together with the piston, while the big end traces a circle whose radius is equal to half the stroke of the piston, i.e. equal to the crank throw.

These conventional types of reciprocating internal-combustion engines are not free from drawbacks, including the fact that they are characterized by low ratios of power output to conversion device weight, of power output to engine weight, and of power output to volume; they have a complicated, heavy, bulky and expensive structure, particularly due to the presence of the connecting rod, which is articulated with respect to the piston and the crank and must also be sized so as to handle flexing and instability (combined bending and compressive stress) and also due to the complexity, bulk and imbalance of the engine shaft.

Moreover, with the conventional crank mechanism it is not possible to provide a constant-volume combustion, as prescribed by the theoretical Otto cycle, or a constant-pressure combustion, as prescribed by the theoretical Diesel cycle.

### SUMMARY OF THE INVENTION

The aim of the present invention is to eliminate the above-noted drawbacks of conventional internal-combustion engines by providing an internal-combustion engine with improved reciprocating action which allows to increase the ratio of power output to weight of the energy conversion device, of power output to engine weight, and of power output to dimensions of said engine, to reduce the complex articulations in the transmission of motion, to simplify the elements for transmitting power from the combustion chamber to the output of the engine shaft, to attenuate the imbalances of the alternating masses and to contain manufacturing costs.

Within the scope of this aim, an object of the present invention is to provide a structure which is simple, relatively easy to provide in practice, safe in use, effective in operation, and of relatively low cost.

This aim and this and other objects are achieved by the present internal-combustion engine with improved reciprocating action, of the type comprising at least one hollow cylinder inside which there is provided a chamber for the activity of a working fluid and having an end being closed by a head provided with intake and exhaust valves for said fluid and an opposite end being closed by a piston which can slide with a reciprocating rectilinear motion in said chamber, characterized in that it comprises a device for converting the reciprocating rectilinear motion into a rotary motion of an engine shaft constituted by at least one pusher rod which is substantially perpendicular to the longitudinal axis of the shaft and has a first end associated with the piston and a second end provided with pusher elements, and by at least one shaped eccentric element being keyed on said shaft and on which there is provided a circuit element whose path can be followed by said pusher elements which are mechanically coupled thereto, the activity of said fluid in the chamber being adapted to impart to the piston a thrust for actuating the rod with a reciprocating rectilinear motion parallel to itself, with the sliding of the pusher elements in the circuit element in order to transfer said thrust to said eccentric element for the rotary actuation of the engine shaft.

### BRIEF DESCRIPTION OF THE DRAWINGS

Further characteristics and advantages of the present invention will become better apparent from the detailed description of a preferred but not exclusive embodiment of an internal-combustion engine with improved reciprocating action, illustrated only by way of non-limitative example in the accompanying drawings, wherein:

FIG. 1 is a partially sectional view of a first embodiment of an internal-combustion engine with improved reciprocating action according to the invention, at the beginning of the intake step;

FIG. 2 is a partially sectional view of the engine of FIG. 1 at the beginning of the compression step;

FIG. 3 is a partially sectional view of the engine of FIG. 1 at the beginning of the power step;

FIG. 4 is a partially sectional view of the engine of FIG. 1 at the beginning of the exhaust step;

FIG. 5 is a schematic sectional view of a four-cylinder engine according to the invention;

FIG. 6 is a partially sectional view of a second embodiment of an engine according to the invention;

FIG. 7 is a partially sectional view of a third embodiment of an engine according to the invention;

FIG. 8 is a partially sectional view of a fourth embodiment of an engine according to the invention;

FIG. 9 is a partially sectional view of a fifth embodiment of an engine according to the invention;

FIG. 10 is a plan view of a possible configuration of the motor according to the invention;

FIG. 11 is an exploded view of the motor of FIG. 10;

FIG. 12 is a cross-sectional view, taken along the plane XII-XII of the motor shown in FIG. 10.

### DESCRIPTION OF THE PREFERRED EMBODIMENTS

With reference to the figures, 1 designates a generic cylinder of an internal-combustion engine with improved reciprocating action according to the invention.

The cylinder 1 is closed at one end by a head 2 which is provided with an intake valve 3 and with an exhaust valve 4 for a working fluid; its opposite end is closed by a piston 5 which can slide with a reciprocating rectilinear motion within said cylinder 1.

The engine according to the invention is a machine of the positive-displacement type, in which the working fluid enters the chamber 2a formed by the internal walls of the cylinder 1, the crown of the piston 5 and the lower surface of the head 2, and evolves thermodynamically inside the chamber 2a when said chamber changes its dimensions.

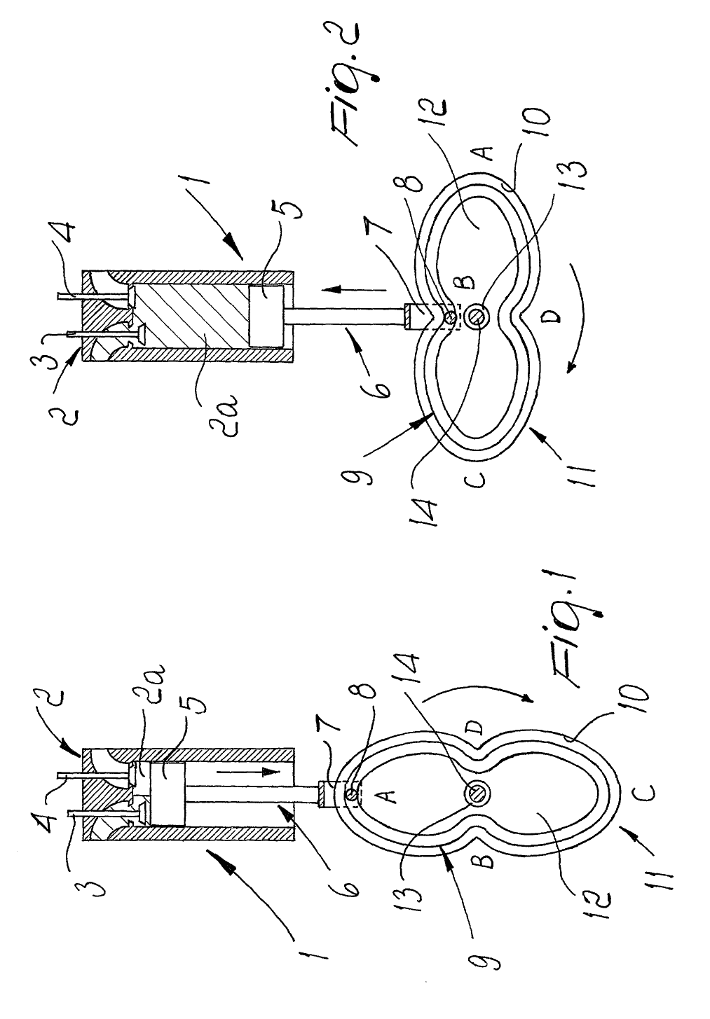

The piston 5 is rigidly associated with a first end, or small end, of a pusher rod or arm 6 having a second end or big end 7 which is for example fork-shaped and has pusher elements, advantageously constituted by a pair of mutually opposite pivots or bearings 8, each of which is mechanically retained so as to slide in a corresponding circuit element 9 or slot formed as a recess between a corresponding outer edge 10 of a shaped eccentric element, constituted by a continuous guiding cam 11 which in the first embodiment (Figures 1 to 4) is shaped like the numeral 8, and the correspondingly raised internal portion 12 of said cam.

The guiding cam 11 is keyed, by means of a central bilateral hub 13, on a shaft 14 which is advantageously rectilinear and substantially perpendicular to the rod 6 and becomes a driving shaft due to the energy conversion that moves the piston 5.

In Figures 1 to 5, the profile of the circuit element 9 is constituted by two lobes which are mutually radiused and offset at 180° to each other with two segments for each one of said lobes, so that the evolution of the working s fluid in the chamber 2a occurs through 360° of the rotation of the shaft 14.

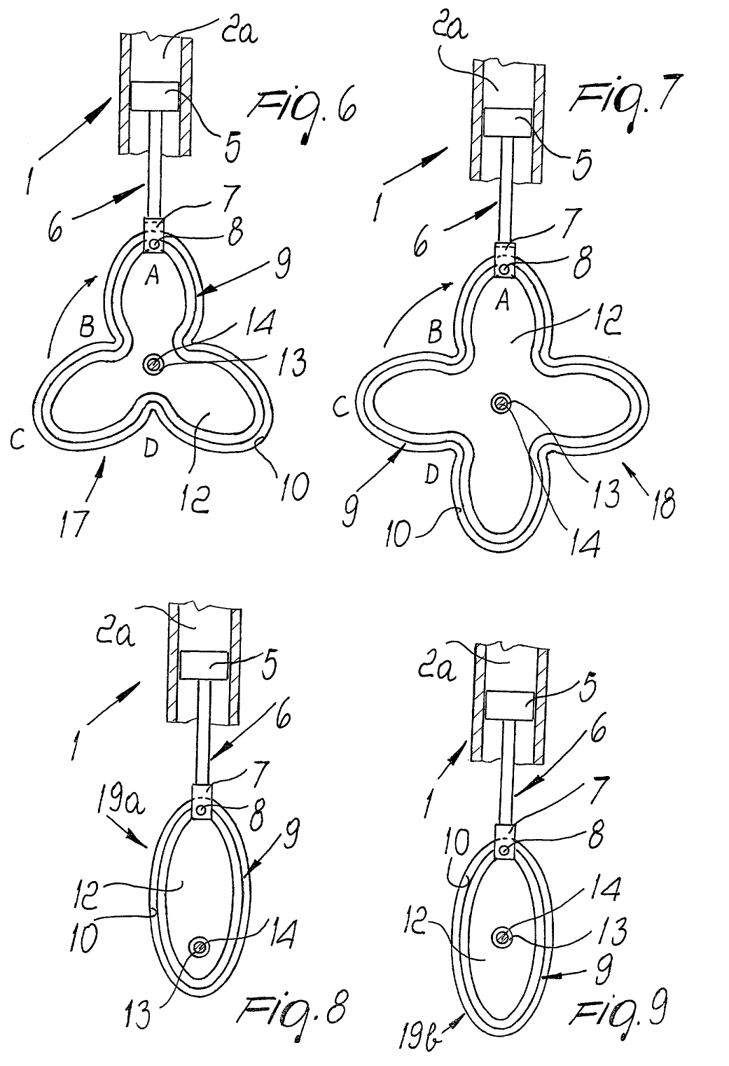

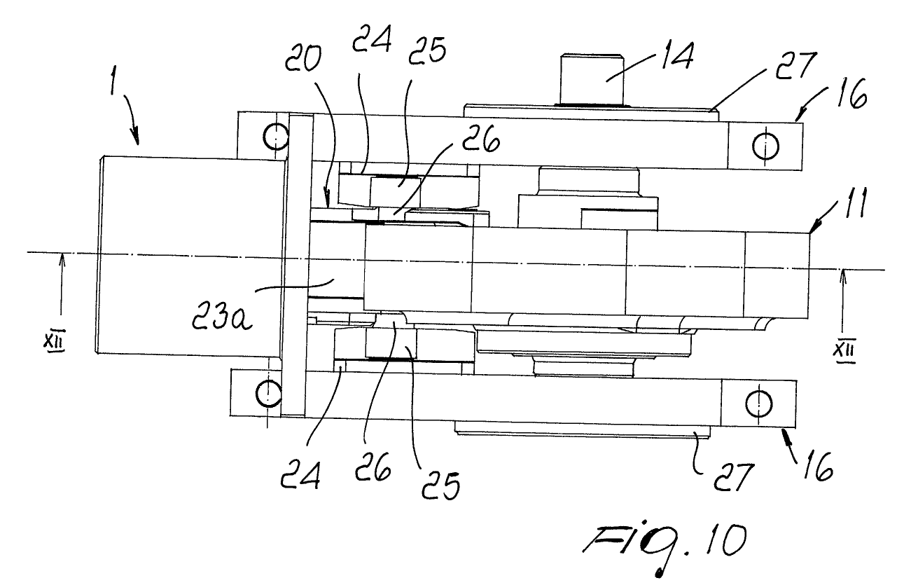

The reference letters A, B, C, D further designate the theoretical points between which the four steps occur along the respective segments AB, BC, CD, DA of the circuit element 9; 15 (FIG. 5) designates optional bearings provided with rolling bodies; 16 designates the stand supports of the engine shaft 14; 17 and 18 designate continuous cams which relate to the second and third embodiments of the invention (FIGS. 6 and 7) which respectively have a three- and four-lobed contour; 19aand 19b designate cams related to the fourth and fifth embodiments of the invention which have an olive-shaped contour which can be divided into two pairs of segments, with the shaft 14 in the eccentric position and in the central position, respectively.

The piston 5 transmits the motion to the engine shaft 14 by way of the big end 7 of the rod 6, which is retained mechanically by means of the pivots 8 so that it slides, following the circuit element 9 that has the profile of the guiding cam 11 which rotates at the rotation rate of the shaft 14.

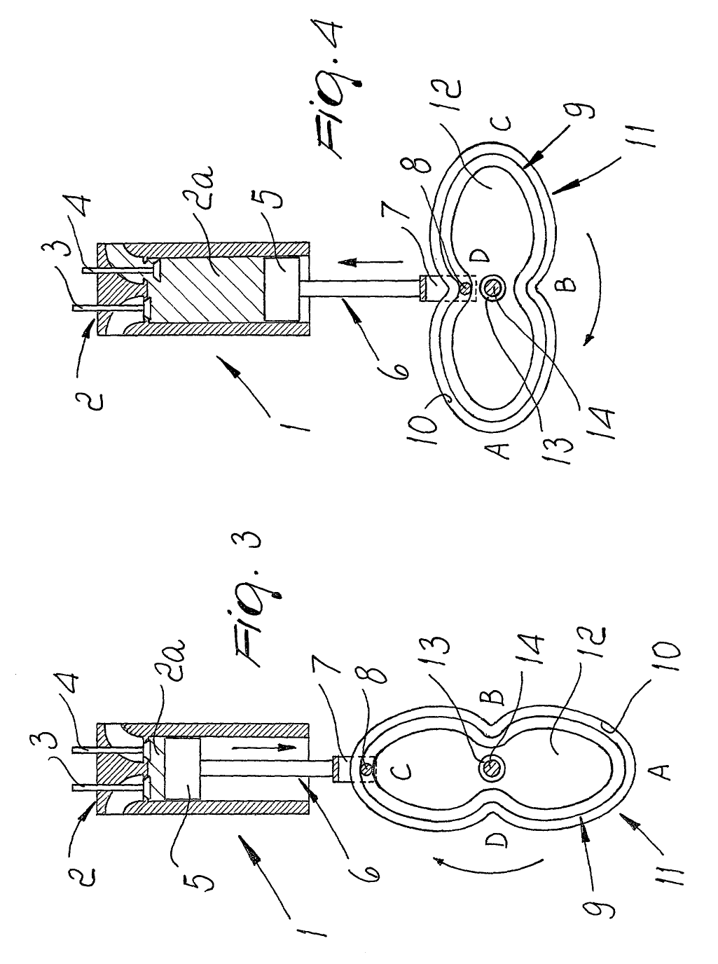

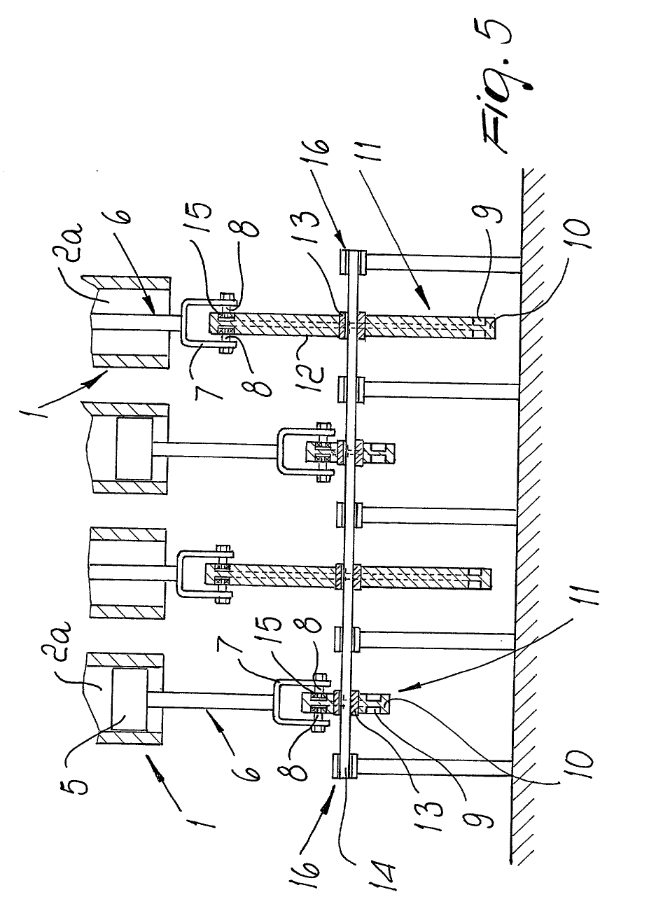

The motion of the shaft 14 is constant, except for periodic oscillations due to torsional vibrations; the piston 5 is instead provided with a periodic motion whose speed can vary between two nil values: the top dead center (TDC), shown in FIGS. 1 and 3, to which the points A and C of the circuit element 9 correspond, and the bottom dead center (BDC), shown in FIGS. 2 and 4, to which the points B and D of the circuit element 9 correspond.

The TDC and the BDC are defined respectively as the furthest and closest position of the crown of the piston 5 with respect to the shaft 14.

During a stroke from the TDC to the BDC, and vice versa, the piston 5 defines a volume, known as displacement, which is calculated as the product 30 of the surface of the crown of the piston 5 by its stroke.

The intake and discharge of the working fluid in/from the cylinder 1 are regulated respectively by the intake valve 3 and by the exhaust valve 4.

FIG. 1 illustrates the intake step, in which a fluid, particularly air or a mixture of air and fuel, enters the chamber 2a through an intake duct being connected to the intake valve 3, which is open, while the exhaust valve 4 is closed.

The intake or induction step begins when the piston 5 is at the TDC, the pivots 8 being located at the point A of the circuit element 9 of the guiding cam 11, and ends when the piston 5 reaches the BDC, the pivots 8 being located at the point B of the circuit element 9; therefore it is completed in 90° of the rotation of the shaft 14.

Likewise, FIG. 2 illustrates the compression step, which begins with the piston 5 at the BDC, with the intake valve 3 in the closure step and the exhaust valve 4 fully closed, and ends with the piston 5 at the TDC.

The compression step corresponds to the segment BC of the circuit element 9 of the guiding cam 11 along which the pivots 8 travel and is completed in the subsequent 90° of the rotation of the shaft 14.

FIG. 3 instead illustrates the useful power step, which begins with the piston 5 at the TDC and with the valves 3 and 4 closed and ends when the piston 5 reaches the BDC.

The useful step corresponds to the segment CD of the circuit element 9 of the guiding cam 11 and is completed in 90° of the rotation of the shaft 14.

Finally, FIG. 4 illustrates the exhaust step, which begins with the piston 5 at the BDC, the exhaust valve 4 open, and the intake valve 3 closed, and ends when the piston 5 reaches the TDC.

The exhaust step corresponds to the segment DA of the circuit element 9 of the guiding cam 11 and is completed in 90° of the rotation of the shaft 14.

It is noted that during the strokes of the piston 5 from the TDC to the BDC and vice versa, the big end 7 of the rod 6, by following the profile of the guiding cam 11, moves with a rectilinear motion and the rod 6 remains always parallel to itself, differently from what occurs for the connecting rod in a conventional ordinary crank mechanism.

The improved engine according to the first embodiment of the invention is therefore a four-stroke engine in which the various steps of the cycle occur sequentially during a single revolution (360°) of the engine shaft, whereas in conventional engines these steps occur sequentially during two revolutions.

Accordingly, the number of useful steps per cycle is doubled: the power in output from the engine shaft theoretically doubles with respect to the power in output from the shaft of an equivalent traditional four-stroke engine, cylinder capacity and rotation rate being equal.

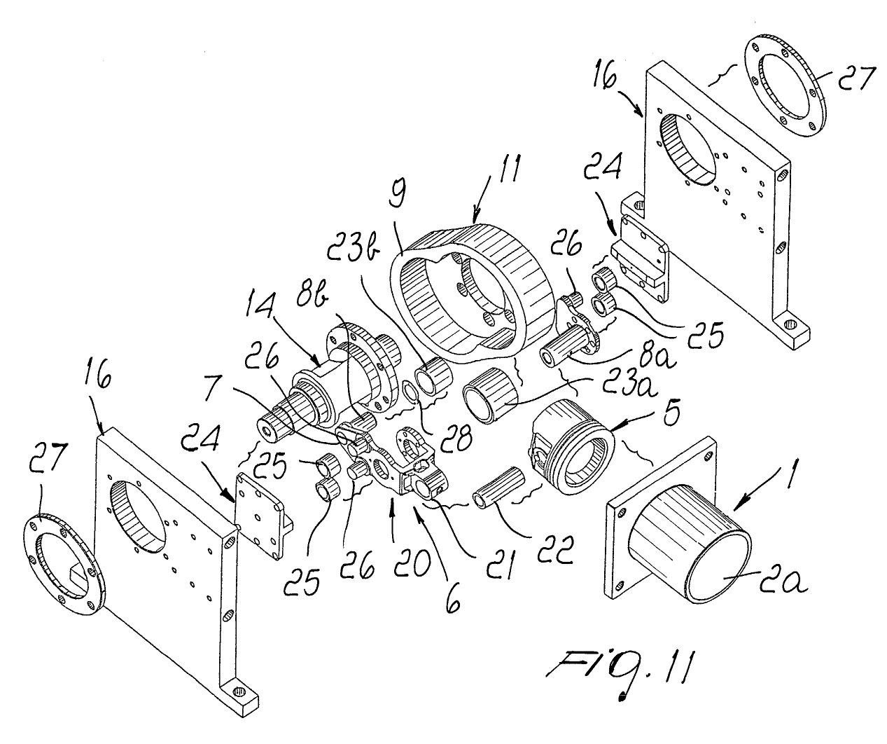

Advantageously, the number of useful steps obtainable at each revolution of the engine shaft 14 increases by appropriately modifying the profile of the guiding cam 11, i.e. the circuit element 9; in particular, as shown in FIGS. 6 to 9, which relate to different embodiments of the invention, there are three, four or more than four useful steps per revolution.

The circuit element 9 of the guiding cam 17 is in fact constituted (FIG. 6) by three lobes which are mutually radiused and offset at 120° to each other with two segments each, so that the evolution of the working fluid in the chamber 2a occurs through 240° of the rotation of the shaft 14; or (FIG. 7) it is constituted, in the guiding cam 18, by four mutually radiused lobes which are offset at 90° to each other, with two segments each, so that the evolution of the working fluid in the chamber 2a occurs through 180° of the rotation of the shaft 14.

Correspondingly, the power in output from the shaft 14 is trebled, quadrupled and in any case increases with respect to an equivalent four-stroke engine of the conventional type for an equal cylinder capacity and rotation rate.

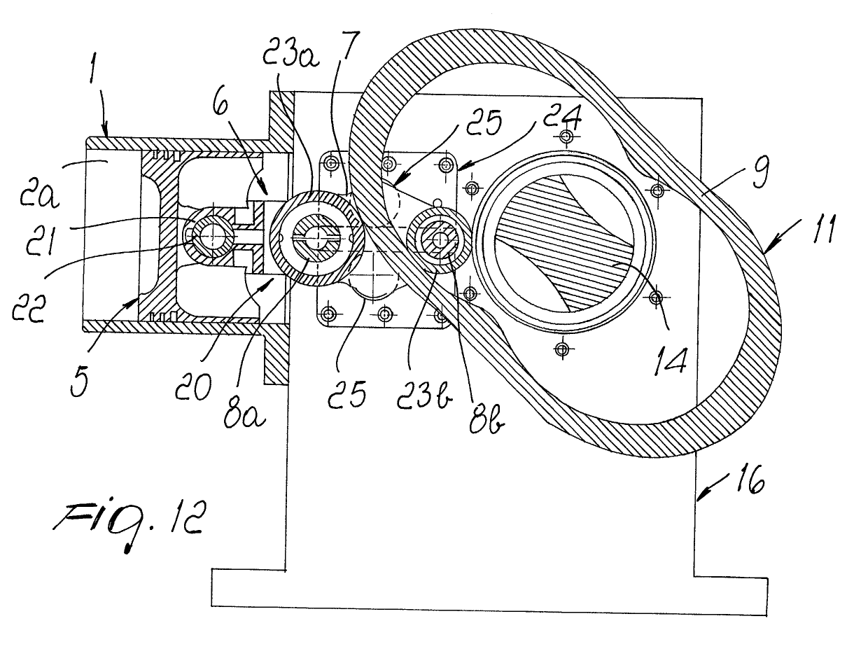

A possible configuration of the motor, according to the invention, is shown in FIGS. 10, 11 and 12, wherein the guiding cam 11 and the profile of the circuit element 9 have the shape of the numeral 8 and are constituted by two lobes joint together and offset at 180° one from the other, while the rod 6 is constituted by a rocker arm 20.

The rocker arm has a first end (wing) 21 connected through the gudgeon 22 to the piston 5 and the opposite end or big end 7 connected to the pushing elements constituted by a pushing pin 8a joint to a respective pushing roller 23a and by a return pin 8b joint to a respective return roller 23b; the rollers 23a and 23b are arranged so as to mate with the circuit element 9 along which they are forced to run.

Guiding elements, further indicated by 24, for rectilinear guiding of the rocker arm 20, are fixed parallel and opposed to each other, to the supports 16; to said supports 16, respective guide rollers 25 are slidingly coupled, which are mounted about corresponding guide pins 26 protruding at opposed sides of the rocker arm 20; 27 designates shoulders and 28 a washer.

The working fluid may consist in gasoline, gas oil, methane, or similar.

Moreover, the presence of valves, ducts or other intake and exhaust means can be selected in each instance according to particular requirements.

As regards the radiused portions between the circuit segments that respectively correspond to a cycle step each, their radius of curvature is smaller than that of said segments but is still such as to allow the pusher element to pass rapidly without jamming and with acceptable friction.

The means that cooperate with the cavity in which energy conversion occurs can be the most disparate for the practical execution of the invention; in particular, they may also be conventional means for developing and utilizing the energy transformation.

As regards the circuit element, besides being constituted by a slot, it might also protrude, this of course entails adapting the shape of the pusher elements associated with the rod 6.

In practice it has been found that the described invention achieves the intended aim and objects.

The power in output from the engine shaft in fact increases (doubles, trebles, quadruples) with respect to an equivalent engine of the conventional type, for an equal cylinder capacity and rpm rate, as a consequence of the corresponding increase in the number of useful steps that can be obtained at each revolution of the engine shaft.

Moreover, the motion of the entire rod 6 is of the reciprocating type in a single direction and the rod or arm 6 remains always parallel to itself: accordingly, the kinematic behavior of the device (crank mechanism) corresponds to the behavior that would occur in a conventional-type engine with a connecting rod of infinite length.

The rule of said motion is therefore of the merely harmonic type, generating a perfectly cosinusoidal acceleration profile, eliminating all the components of an order higher than the first.

A direct consequence of what has been stated above is the elimination of the forces of inertia of the alternating second-order masses, which are one of the most important causes of vibrations in internal-combustion engines.

Moreover, it is noted that the presence of the guiding cam 11, which rotates at the rotation rate of the engine shaft 14 and controls the movement of the rod 6 and therefore of the piston 5, allows to set the steps of the engine in relation to the profile given to said cam; accordingly, it allows to set the most appropriate rule of motion in the various steps of the cycle.

In particular, by appropriately shaping the profile of the guiding cam 11, the combustion step can be provided according to an ideal constant-volume cycle by making the piston remain proximate to the TDC for a period which is related to the combustion process.

In fact, as it is known from thermodynamics, the cycle of an internal-combustion engine with constant-volume combustion (Otto cycle) is the one that is characterized by the highest thermodynamic efficiency with respect to other cycles that can be proposed, such as the Diesel cycle with combustion at constant pressure or the Sabathé mixed-type cycle, to which the current cycles of internal-combustion engines of the spark-ignition and compression-ignition types can be traced back.

Accordingly, the thermodynamic cycles that can be provided with the improved engine according to the invention have a higher thermodynamic efficiency than the cycles of current internal-combustion engines, with a consequent reduction in specific consumption and an increase in the power that can be obtained from the engine for an equal cylinder capacity and rpm rate.

The improved engine according to the invention therefore allows to increase the thermodynamic efficiency of the transformation cycle of the working fluid, to increase the power in output from the engine shaft and to reduce the vibrations to which the components of the engine are subjected.

The invention thus conceived is susceptible of numerous modifications is and variations, all of which are within the scope of the inventive concept.

All the details may further be replaced with other technically equivalent ones.

In practice, the materials used, as well as the shapes and the dimensions, may be any according to requirements without thereby abandoning the scope of the protection of the appended claims.

The disclosures in Italian Patent Application No. MO2000A000031 from which this application claims priority are incorporated herein by reference.

What is claimed is:

1. An internal-combustion engine with improved reciprocating action, comprising: at least one hollow cylinder; a chamber provided inside said cylinder for enclosing a working fluid; a head closing a first end of said cylinder chamber; intake and exhaust valves for said fluid provided at said head; a piston closing at a second end thereof said chamber and which is slidable with a reciprocating rectilinear motion in the chamber; an engine shaft; and a device for converting the reciprocating rectilinear motion of the piston into a rotary motion of the engine shaft, wherein said device is constituted by at least one pusher rod, which is substantially perpendicular to a longitudinal axis of said shaft and has a first end connected to said piston, by pusher elements provided at a second end of said pusher rod, and by at least one shaped eccentric element which is keyed on said shaft and has a circuit element including a path at which said pusher elements are mechanically coupled so as to perform a guided motion therealong, activity of said fluid in said chamber imparting to said piston a thrust for actuating said rod with a reciprocating rectilinear motion parallel to itself, and guidingly moving said pusher elements of said path of said circuit element in order to transmit said thrust to said eccentric element for conversion thereof into rotary motion of said engine shaft.

2. The engine of claim 1, wherein said circuit element is shaped so that said path has a profile constituted by two mutually radiused lobes which are offset at 180° with respect to each other, with two segments for each one of said lobes, activity of said working fluid in said chamber occurring through 360° of rotation of said engine shaft.

3. The engine of claim 1, wherein said circuit element is shaped so that said path has a profile constituted by three mutually radiused lobes which are offset at 120° to each other, with two segments for each one of said lobes, activity of said working fluid in said chamber occurring through 240° of rotation of said engine shaft.

4. The engine of claim 1, wherein said circuit element is shaped so that said path has a profile constituted by four lobes which are mutually radiused and offset at 90° with respect to each other, with two segments for each one of said lobes, activity of said working fluid in said chamber occurring through 180° of rotation of said engine shaft.

5. The engine of claim 1, wherein said circuit element with said path is constituted by a recess proximate to an edge of said shaped eccentric element.

6. The engine of claim 1, wherein said circuit element with said path is constituted by a protruding element arranged so as to protrude proximate to an edge of said shaped eccentric element.

7. The engine of claim 1, wherein said pusher elements are constituted by any of pivots and bearings.

8. The engine of claim 1, wherein said engine shaft is rectilinear.
